(19) United States
(12) Patent Application Publication
(10) Pub. No.: US 2025/0245240 A1
(43) Pub. Date: Jul. 31, 2025

(54) AUTOMATED SWITCHOVER COMPLIANCE DASHBOARD

(71) Applicant: SAUDI ARABIAN OIL COMPANY, Dhahran (SA)

(72) Inventors: Quassem S. Bojbarah, Dhahran (SA); Basel O. Bin Duhaish, Dhahran (SA); Fahad A. Alhussaini, Dhahran (SA); Salem K. Turki, Dhahran (SA)

(73) Assignee: SAUDI ARABIAN OIL COMPANY, Dhahran (SA)

(21) Appl. No.: 18/427,599

(22) Filed: Jan. 30, 2024

(51) Int. Cl. G06F 16/26; G06F 16/25

(52) U.S. Cl. CPC G06F 16/26; G06F 16/254

(57) ABSTRACT

A method of automatically managing switchover compliance includes: automatically retrieving data, from a database, for each asset among a plurality of assets, wherein the data comprises information indicating whether each asset is operational or nonoperational before and on a due date for switchover; determining whether each asset is operational or nonoperational based on the data before and on the due date for switchover; in response to an asset among the plurality of assets being operational, showing the asset as operational on a dashboard display and counting the asset as complying with the switchover program; in response to the asset being nonoperational, determining, based on the data, whether the asset is down for planned maintenance; and calculating and showing a switchover compliance rate for the plurality of the assets based on compliance status of the plurality of assets.

### BACKGROUND

Asset switchover ensures that assets at a facility are fairly operated. This is done by maintaining a balance between assets' up and down times and preventing excessive usage or prolonged idle time of the assets, both of which may reduce the assets' life. Asset switchover compliance may be a corporate requirement, which is traditionally manually calculated and recorded by a reliability engineer at the end of each month. To this end, the reliability engineer manually collects records of the assets and justifications for their operational statuses from operations at the end of each month and then manually calculates the assets' switchover compliance from the collected records. This process has various drawbacks such as being time consuming and unreliable.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

One or more embodiments disclosed herein relate to a method of automatically managing switchover compliance performed by a switchover compliance dashboard. The method comprises: automatically retrieving data, from a database, for each asset among a plurality of assets, wherein the data comprises information indicating whether each asset is operational or nonoperational before and on a due date for switchover; determining whether each asset is operational or nonoperational based on the data before and on the due date for switchover; in response to an asset among the plurality of assets being operational, showing the asset as operational on a dashboard display and counting the asset as complying with the switchover program; in response to an asset among the plurality of assets being nonoperational, showing the asset as nonoperational on the dashboard display; in response to the asset being nonoperational, determining, based on the data, whether the asset is down for planned maintenance; in response to the nonoperational asset being down for planned maintenance, showing the asset as being down for planned maintenance on the dashboard display and counting the asset as complying with the switchover program; in response to the nonoperational asset not being down for planned maintenance, determining whether the asset is compliant with the switchover program based on a remaining time for switchover of the asset; based on a result of determining whether the nonoperational asset is compliant with the switchover program, showing a compliance status of the asset on the dashboard display; and calculating and showing a switchover compliance rate for the plurality of the assets based on compliance status of the plurality of assets.

One or more embodiments disclosed herein relate to a system for automatically managing switchover compliance. The system comprises: a plurality of assets; and a server. The server is configured to: automatically retrieve data, from a database, for each asset among the plurality of assets, wherein the data comprises information indicating whether each asset is operational or nonoperational before and on a due date for switchover; determine whether each asset is operational or nonoperational based on the data before and on the due date for switchover; in response to an asset among the plurality of assets being operational, show the asset as operational on a dashboard display and count the asset as complying with the switchover program; in response to an asset among the plurality of assets being nonoperational, show the asset as nonoperational on the dashboard display; in response to the asset being nonoperational, determine, based on the data, whether the asset is down for planned maintenance; in response to the nonoperational asset being down for planned maintenance, show the asset as being down for planned maintenance on the dashboard display and count the asset as complying with the switchover program; in response to the nonoperational asset not being down for planned maintenance, determine whether the asset is compliant with the switchover program based on a remaining time for switchover of the asset; based on a result of determining whether the nonoperational asset is compliant with the switchover program, show a compliance status of the asset on the dashboard display; and calculate and show a switchover compliance rate for the plurality of the assets based compliance status of the plurality of assets.

One or more embodiments disclosed herein relate to a non-transitory computer readable medium (CRM) storing instructions for performing an operation of automatically managing switchover compliance. The operation comprises: automatically retrieving data, from a database, for each asset among a plurality of assets, wherein the data comprises information indicating whether each asset is operational or nonoperational before and on a due date for switchover; determining whether each asset is operational or nonoperational based on the data before and on the due date for switchover; in response to an asset among the plurality of assets being operational, showing the asset as operational on a dashboard display and counting the asset as complying with the switchover program; in response to an asset among the plurality of assets being nonoperational, showing the asset as nonoperational on the dashboard display; in response to the asset being nonoperational, determining, based on the data, whether the asset is down for planned maintenance; in response to the nonoperational asset being down for planned maintenance, showing the asset as being down for planned maintenance on the dashboard display and counting the asset as complying with the switchover program; in response to the nonoperational asset not being down for planned maintenance, determining whether the asset is compliant with the switchover program based on a remaining time for switchover of the asset; based on a result of determining whether the nonoperational asset is compliant with the switchover program, showing a compliance status of the asset on the dashboard display; and calculating and showing a switchover compliance rate for the plurality of the assets based on compliance statuses of the plurality of assets.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 illustrates a system for automated switchover compliance in accordance with one or more embodiments.

FIG. 2 illustrates data communication in an automated switchover system in accordance with one or more embodiments.

FIG. 3 illustrates communication in the system for automatic switchover compliance in accordance with one or more embodiments.

FIG. 4 illustrates a flowchart for an operation of an automatic switchover compliance dashboard in accordance with one or more embodiments.

FIG. 5 shows an implementation example of the automatic switchover compliance dashboard in accordance with one or more embodiments.

FIG. 6 shows an implementation example of the automatic switchover compliance dashboard in accordance with one or more embodiments.

FIG. 7 shows an implementation example of the automatic switchover compliance dashboard in accordance with one or more embodiments.

FIG. 8 shows an implementation example of the automatic switchover compliance dashboard in accordance with one or more embodiments.

FIG. 9 illustrates a flowchart for the operation of the automatic switchover compliance dashboard in accordance with one or more embodiments.

FIG. 10 shows a computer system for the automatic switchover compliance dashboard in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

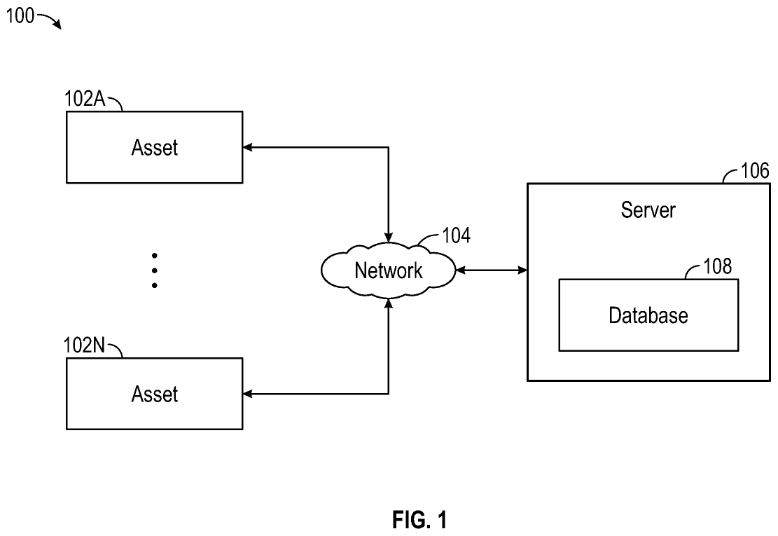

In the following description of FIGS. 1-10, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a wellbore” includes reference to one or more of such wellbores.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Embodiments disclosed herein are regarding an automated switchover compliance dashboard (hereinafter referred to as the “dashboard”) that provides information about asset compliance for switchover. For this purpose, the dashboard automatically provides information about assets, including their due and overdue days, asset operation history, whether it is scheduled for planned maintenance, etc., and calculates a switchover compliance rate of the assets. The dashboard potentially improves reliability and integrity of facility operations. The dashboard automatically collects all required assets' records from Plant Information (PI) client applications such as “ProcessBook” and “DataLink” and calculates the assets' switchover compliance.

According to one or more embodiments, asset switchover strategy is to ensure that assets at a facility are fairly operated by maintaining a good balance between up and down times of the assets. This is to prevent excessive usage or prolonged idle times of the assets, which reduce the assets' life. For example, the facility may operate a range of assets, each critical to different stages of a production process. Examples of such assets include injection pumps, booster pumps, modules, or any other equipment. To manage these assets effectively and extend their operational life, the facility may implement an asset switchover strategy. The strategy may involve rotating the usage of similar assets to ensure a balanced operational load. This means that instead of using one asset continuously until it needs repair, the facility alternates between assets for specific tasks.

According to one or more embodiments, to monitor and implement the asset switchover strategy, the facility can use the dashboard. The dashboard may display real-time data on each asset, such as its current operational status (e.g., up or down), total running hours, maintenance schedule, and usage history. According to one or more embodiments, when an asset nears its maximum recommended usage time or remains idle for an extended period, the dashboard may alert a facility operator to initiate a switchover or investigate the asset.

Asset switchover compliance may be a corporate requirement, which is conventionally manually calculated by a reliability engineer at the end of each month. Specifically, the reliability engineer manually collects asset records at the end of each month and manually calculates the assets' switchover compliance rate based on information indicating which assets are operational and which are nonoperational. The manual switchover calculation, makes the switchover unreliable, slow, and inefficient.

On the other hand, the dashboard according to one or more embodiments ensures proper switching between running and standby assets. This dashboard automatically and instantaneously calculates switchover compliance, counts the remaining time (e.g., remaining days) for switchover for each asset, may automatically notify operation and maintenance departments about overdue assets or assets that are nonoperational close to the due date (i.e., the remaining time to switchover being equal to or less than a threshold), and may log any overdue asset for recording and investigation. In the embodiments described herein, “nonoperational” refers to an asset that is down or that does not operate to a standard, which may be determined by the facility, to be considered as not properly running. Similarly, “operational” refers to an asset that operates within a facility standard to be considered as properly running.

In one or more embodiments, the dashboard synthesizes information from multiple data sources, including, but not limited, to a Plant Information (PI) database, enabling monitoring of real-time data in a variety of user-defined formats. The dashboard may be equipped with various functionalities such as including an escalation protocol for addressing due and overdue assets, capability to set performance targets, and mechanisms for delivering recommendations and notifications. Furthermore, the dashboard may have live data visualization tools that feature data extraction capabilities.

According to one or more embodiments, data retrieval is conducted by a backend database server, which may fetch information from a PI corporate server in real-time, for example utilizing a SQL query/job that is executed periodically across all departmental assets. This query may initiate a series of operations that involve triggering, manipulation, and computation of data corresponding to assets that have ceased operation, based on the specific time they became inactive. Subsequently, records of these inactive assets may be transferred to an audit table, where they undergo further processing and are compared against internal departmental benchmarks for down-time. Additionally, the dashboard may provide functionality for maintenance engineers to annotate assets that are earmarked for maintenance or Test and Inspection (T&I) as Down for Maintenance (DFM), thereby effectively removing them from the active switchover monitoring list.

FIG. 1 illustrates a system (100) for automatic switchover between assets (102A) through (102N) according to one or more embodiments. The system (100) includes a plurality of assets (102A) through (102N) and a server (106). According to one or more embodiments, the dashboard may be implemented on the server (106). The assets (102A) through (102N) and the server (106) may be interconnected by way of a network (104). The network (104) may be, for example, a wide area network (WAN), a local area network (LAN), and/or the internet. In addition, the network (104) may be comprised of several networks such as an LTE or 5G network connected via the internet to a company LAN. Further, assets (102A) through (102N) may utilize a tunnel, such as a Virtual Private Network (VPN) to access the server (106). To utilize the VPN or other security protocol, assets (102A) through (102N) may be required to perform authentication or otherwise provide user credentials. In one or more embodiments, the server (106) may have a database (108) or may be connected to the database (108) to fetch or send data.

In one or more embodiments, the assets (102A) through (102N) are maintained via an inventory source, and are listed in a master inventory included in database (108). For example, the server (106) may traverse the network (104) to discover new assets in an inventory source, such as by polling active assets on the network (104), and may list any newly discovered assets in the database (108). Alternatively, when a new asset comes online on network (104), the new asset may register itself with an inventory source, and may notify the server (106) to be added to the list in the database (108). In one or more embodiments, an asset manager may add the new asset to the inventory source.

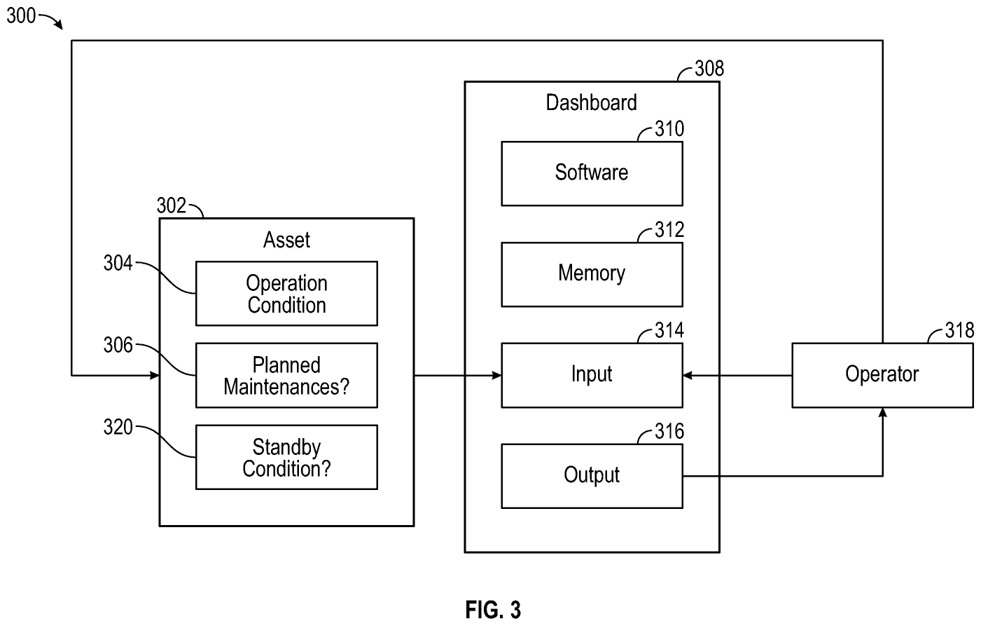

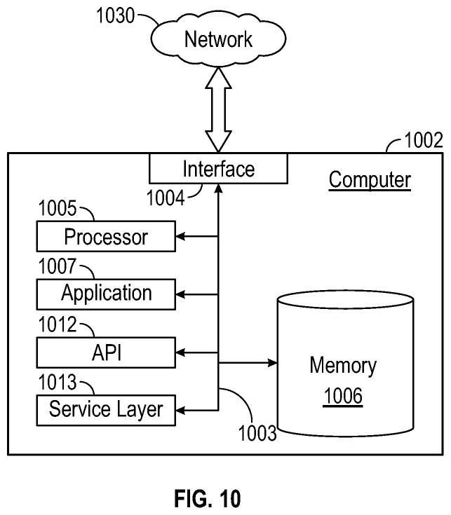

Additionally, the server (106) may poll assets in the master inventory included in database (108) for various status by retrieving a compliance rule, and may determine the compliance of each asset. The system (100) is further described with reference to FIG. 3. In one or more embodiments, the assets(102A) through (102N) may be assets in a facility such as various pumps, modules, or other type of equipment. In some embodiments, the server (106) may be implemented in one or more computers such as a computer described with reference to FIG. 10.

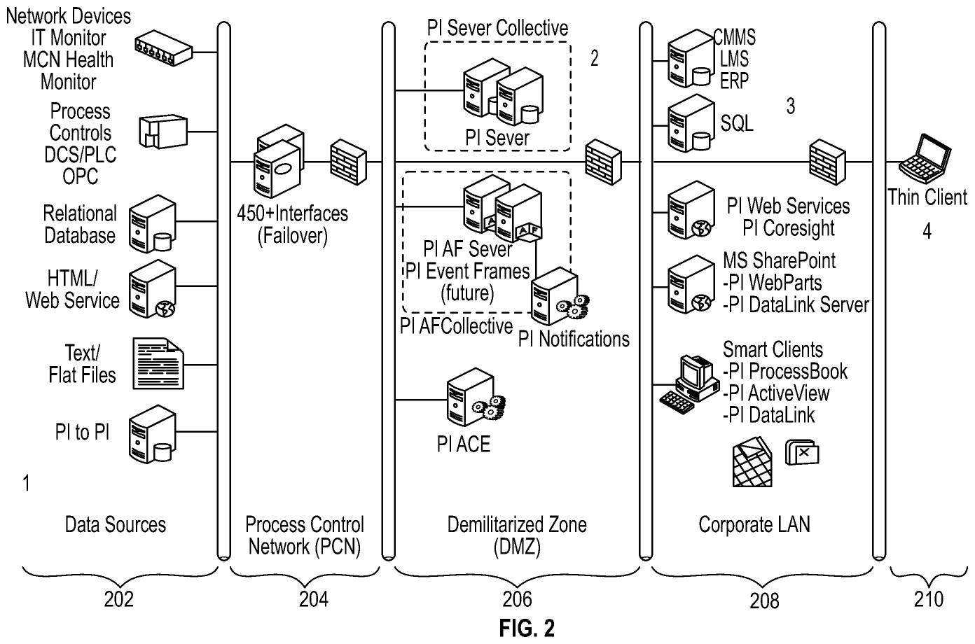

FIG. 2 is a diagram that illustrates retrieving data using the concept of Extract, Transform, and Load (ETL). Specifically, the diagram represents a typical industrial data architecture, often used in settings like manufacturing plants or other facilities that require tight integration between their operational technology and information technology systems. In FIG. 2, data sources (202) shows various types of systems and repositories where raw data is initially collected before it undergoes the ETL process. In the data sources (202), Network Devices, IT Monitor, and Health Monitor demonstrate hardware devices and software systems that monitor the health and performance of the network. They collect data about network traffic, device status, and system alerts. Process Controls/DCS/PLC/OPC demonstrate the operational control systems used in industrial environments. Distributed Control Systems (DCS) and Programmable Logic Controllers (PLC) are types of hardware used to control manufacturing processes. OPC (OLE for Process Control) is a set of standards for industrial telecommunication. Relational Database is a type of database that stores data in tables with predefined relationships between them. It is a common data source for storing structured data. HTML/Web Service refers to data that can be extracted from web pages or through web services. Web services allow different applications to communicate with each other over the web using standardized formats like XML or JSON. Text/Flat Files are simple data files that contain data in a plain text format. PI to PI is a mechanism to transfer data between PI systems. Each of these components may play a role in the initial stage of the ETL process where data is gathered (Extracted) before it is transformed into a format suitable for analysis and then loaded into a target system for further use.

Process Control Network (PCN) (204) is the operational layer where the actual process control happens. In industrial settings, this may include devices like Distributed Control Systems (DCS), Programmable Logic Controllers (PLCs), and other control hardware. Demilitarized Zone (DMZ) (206) is a physical or logical subnetwork that contains and exposes an organization's external-facing services to an untrusted network, usually the internet. In the context of ETL, the DMZ (206) may serve as a middle ground that allows data to be transferred from the PCN (204) to the corporate network while maintaining security. The DMZ (206) typically hosts servers that can securely communicate with both the PCN (204) and the corporate LAN, acting as a gatekeeper to prevent direct traffic between these zones. Corporate LAN (208) is the corporate local area network where business operations may take place. It is separate from the PCN (204) for security reasons. The data that has been extracted from the PCN (204) and passed through the DMZ (206) will be transformed and loaded into systems in the corporate LAN (208) for purposes such as analysis, reporting, and business decision-making. The flow of data from the data sources (202) through the PCN (204) and DMZ (206) and into the Corporate LAN (208) ensures that operational data is used effectively for business analytics and decision-making while maintaining the security of the operational systems from external threats.

The thin client (210) may be a lightweight computer that is optimized for establishing a remote connection with a server-based computing environment. The server does most of the work, which can include launching software, performing computations, and storing data. According to one or more embodiments, the dashboard may be implemented on the thin client (210).

FIG. 3 illustrates a system (300) including the dashboard (308) in accordance with one or more embodiments. The system (300) is designed to enhance the reliability and integrity of facility operations by providing real-time data and automated compliance calculations for asset switchover procedures. In the system (300), only one asset (302) is shown for simplicity but there are more assets connected to the dashboard (308) and a similar procedure applies to the assets. Through the dashboard (308), an operator (318) can have real-time data about the asset (302) on whether it is compliant with switchover.

The operation condition (304) of the asset (302) comprises information about the asset (302) such as due and overdue days and its operation history. The operation history may comprise information such as amount of time of operation, age, capacity, or compliance standard. The asset (302) may also convey information about any planned maintenance (306). The asset (302) may also convey information on whether the asset is in a standby condition (320). In one or more embodiments, the standby condition (320) refers to a state in which the asset (302) is fully operational and ready to take over functionality from another asset at a moment's notice. An operator may manually enter these pieces of information in a database from which the dashboard (308) can fetch the pieces of information. Alternatively, the asset (302) may comprise or use a computer system that checks for these pieces of information and automatically conveys them to the dashboard (308).

The dashboard (308) pulls the information about operation condition (304) and planned maintenance (306) from the database or from the asset (302) to calculate the switchover compliance. To this end, the dashboard (308) comprises software (310), memory (312), input (314), and output (316). In one or more embodiments, the software (310) may include, for example, SQL codes that fetch the data. The memory (312) stores information required to perform switchover compliance calculations, results, data entry by the operator (318), etc. Alternatively, the database may be stored in the memory (312). The input (314) may be any means for conveying data to the dashboard (308). For example, the input (314) may comprise a receiver that receives data wirelessly or via a cable (e.g., LAN). The input (314) may receive the data from the memory (312) or from a database located outside the memory (312). The input (314) may also comprise an interface for the operator (318) to enter data in the dashboard (308). The interface may comprise, for example, keyboard, touchscreen, wireless interface, etc. The output (316) may comprise an interface to communicate with the operator (318). For example, the output (316) may comprise a display that shows results of the switchover compliance processing (i.e., calculations). According to one or more embodiments, the output (316) may comprise a transmitter that transmits the results to the operator (318). Further, in one or more embodiments, the output (316) may send the results to the operator (318) via email or short messaging service (SMS).

In one or more embodiments, the processing results of the dashboard (308) provide a feedback mechanism to the operator (318) to inform the facility about the status of the asset (302). For example, when the dashboard (308) informs the operator (318) that the asset (302) is overdue for switchover and is not scheduled for planned maintenance, the operator (318) can inform the facility to investigate the issue. In another example, the operator (318) may mark/label the overdue asset for maintenance in the database or in the dashboard, which will apply the changes to the database. For example, the maintenance department of the facility may use the dashboard's input (314) to label the asset (302) as under maintenance in the database. Then, the dashboard (308) automatically updates the database and processes the switchover compliance based on the updated data. In another example, the operator (318) can add comments about the asset (302) to the database.

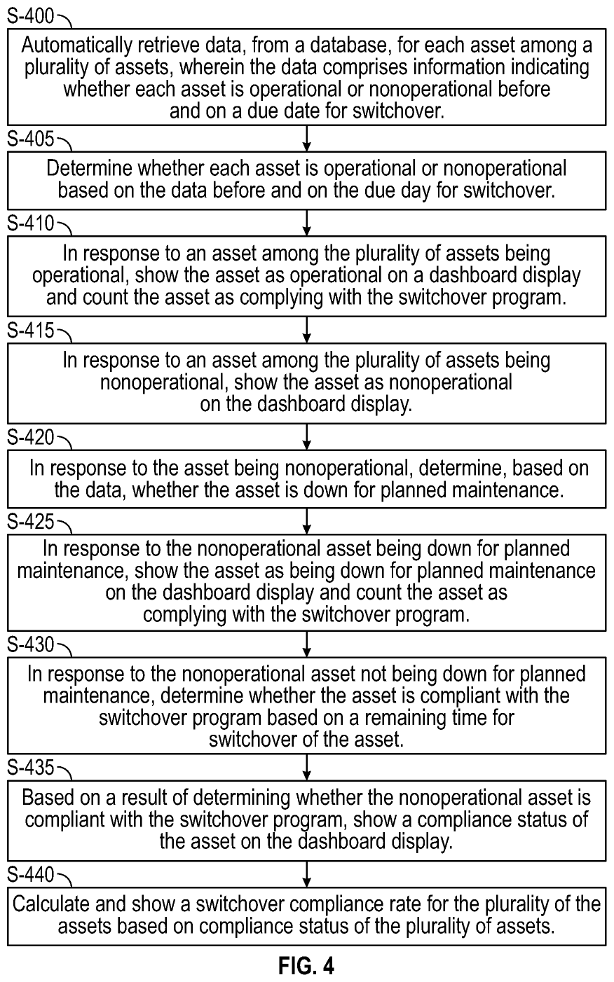

FIG. 4 illustrates a flowchart of a method for a dashboard according to one or more embodiments. More specifically, FIG. 4 depicts a method for the dashboard to automatically process/calculate switchover compliance of a plurality of assets. In one or more embodiments, one or more of the steps shown in FIG. 4 may be omitted, repeated, and/or performed in a different order than the order shown in FIG. 4. Accordingly, the scope of the invention should not be considered limited to the specific arrangement of steps shown in FIG. 4. Steps (S) 400 to 425 shown in FIG. 4 are explained below.

In S-400, the dashboard automatically retrieves data, from a database, for each asset among a plurality of assets. The data includes information indicating whether each asset is operational or nonoperational before and on a due date for switchover. For example, as described above with reference to FIG. 3, the dashboard (308) may fetch information about the asset's operation condition (304) and maintenance (306) from the database, which may be stored in a memory (312). Alternatively, the database could be stored elsewhere. In addition, the dashboard (308) may allow an operator (318) to enter information about operation and maintenance condition of the asset (302) into the database. As described above, the data retrieval may be by using ETL.

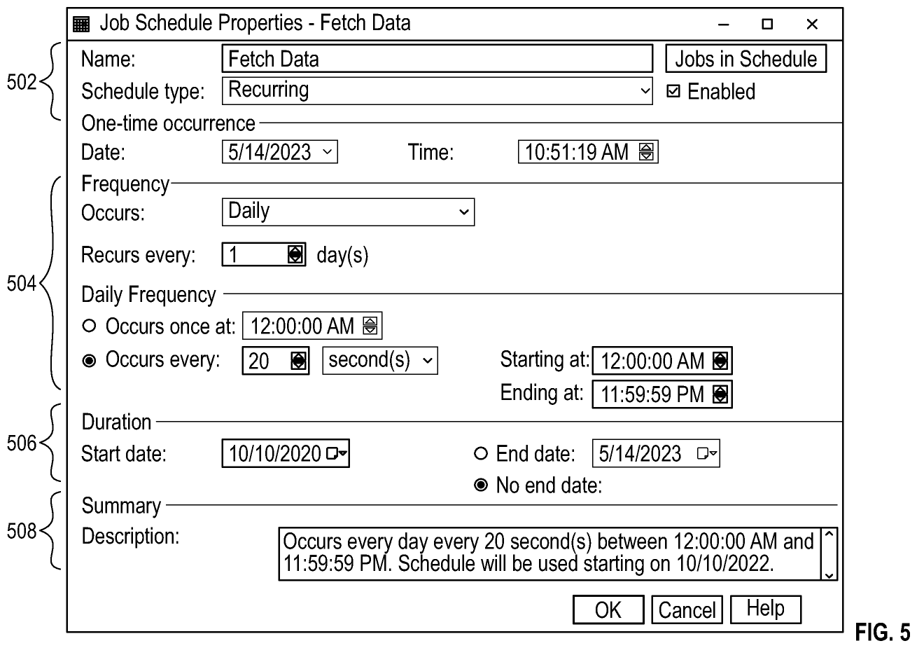

FIG. 5 shows an implementation example of the data retrieval. Specifically, FIG. 5 shows an SQL job for controlling the data retrieval. The SQL job comprises a fetching schedule section (502) that controls fetching the data from the database and whether the fetching is on a recurring schedule or on demand. The SQL job further comprises a frequency section (504), a duration section (506), and a summary section (508). The frequency section (504) enables a user to control the frequency of fetching and processing performed by the dashboard. For example, in FIG. 5, the fetching and processing frequency is daily and every 20 seconds during the 24 hours of the day. The duration section (506) enables the user to configure the start and end dates for the fetching and processing performed by the dashboard. For example, in FIG. 5 the start date is Oct. 10, 2022 and there is no end date. Further, the summary section (508) provides a commenting box where the user can enter descriptive comments, for example regarding the operation of the dashboard. Accordingly, the SQL job shown in FIG. 5 fetches data from the database in accordance with the user's preference. According to FIG. 5, the user may configure the dashboard to retrieve and process the data in real time (e.g., automatically, every 20 seconds).

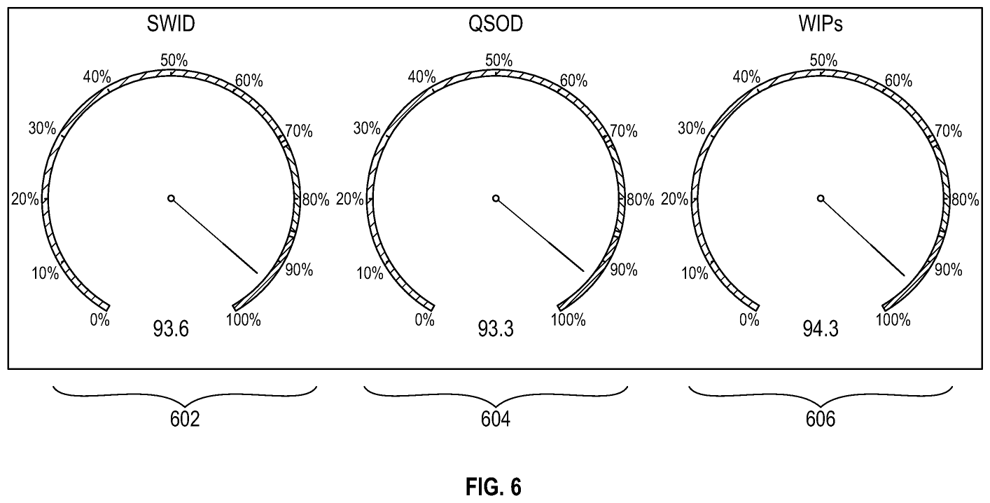

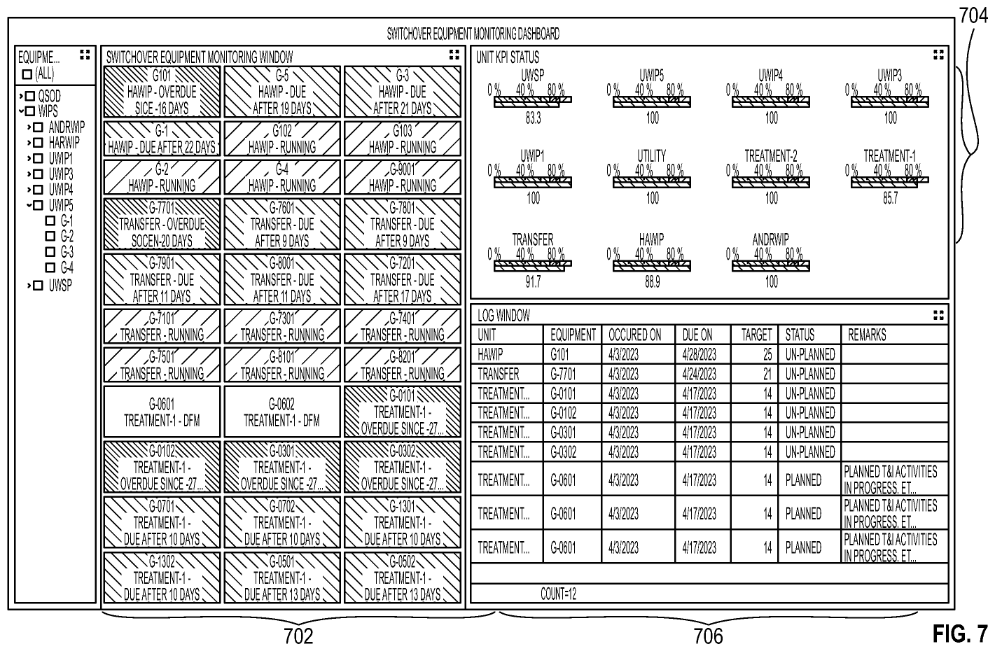

In S-405, the dashboard uses the retrieved data to determine whether each asset is operational or nonoperational before and on the due date for switchover. On this basis, the dashboard can determine the asset switchover compliance of a facility. For example, FIG. 6 shows that the dashboard calculated the switchover compliance rates in three departments of Sea Water Injection Department (SWID) (602), Qurayyah Seawater Injection Division (QSOD) (604), and Water Injection Plants (WIP) (606) as respectively being 93.6%, 93.3%, and 94.3%. These numbers indicate the percentage of assets that are compliant with the respective departmental switchover policy. The dashboard not only calculates the switchover compliance rates, but also helps to keep these rates high, as described further below for example with reference to FIGS. 7-9. According to one or more embodiments, the dashboard can show the calculated rates by a color on a dashboard display. In one or more embodiments, the dashboard display may be a computer display, a smartphone display, or any other means by which the dashboard can show the processing output of the dashboard to the operator. Examples of the dashboard display are described with reference to FIGS. 6, 7, and 10, in accordance with one or more embodiments. In one or more embodiments, as an example, Green indicates satisfied compliance with the switchover program (ranging from 85% to 100%), Yellow indicates partial compliance with the switchover program (ranging from 70% to 84.99%), and Red indicates low compliance with the switchover program (less than 70%).

In S-410, in response to an asset among the plurality of assets being operational (i.e., in a running condition), the dashboard shows the operational asset as operational on the dashboard display and counts the asset as complying with the switchover program.

In S-415, in response to an asset among the plurality of assets being nonoperational, the dashboard shows the asset as nonoperational on the dashboard display.

In S-420, in response to the asset being nonoperational, the dashboard determines, based on the data, whether the asset is down for planned maintenance.

In S-425, in response to the nonoperational asset being down for planned maintenance, the dashboard shows the nonoperational asset, on the dashboard display, as being down for planned maintenance and counts the asset as complying with the switchover program.

In S-430, in response to the nonoperational asset not being down for planned maintenance, the dashboard determines whether the asset is compliant with the switchover program based on a remaining time for switchover of the asset. For example, the dashboard calculates the remaining days before the switchover due date of the asset. The dashboard compares the number of the remaining days with a first threshold (“X”) and a second threshold (“Y”), which is less than the first threshold. If the number of the remaining days is equal to or less than the first threshold but more than the second threshold, the dashboard may generate an alert showing that the nonoperational asset is reaching the due date, but still may count the nonoperational asset as complying with the switchover program. Based on the alert, the operator may investigate the asset. However, if the number of the remaining days is equal to or less than the second threshold, the dashboard may generate a different alert showing that the nonoperational asset is critically reaching the due date or is overdue, and may count the nonoperational asset as noncomplying with the switchover program.

In S-435, based on a result of determining whether the nonoperational asset is compliant with the switchover program, the dashboard shows a compliance status of the asset on the dashboard display. For example, as described below with reference to FIG. 7, the dashboard shows the noncompliant assets in red and the compliant assets in green, blue, or grey.

In S-440, the dashboard calculates and shows a switchover compliance rate for the plurality of the assets based on compliance status of the plurality of assets. The dashboard may indicate a level of switchover compliance rate via a color. For example, as described with reference to FIGS. 6 and 7, the dashboard calculates the switchover compliance rates of various departments and associates them with a color to indicate the compliance level of the departments. For example, in FIG. 6 the circles shows the switchover compliance rates. In each circle, compliance rate of 0-70% is shown in red (not good), 70-85% is shown in yellow (acceptable), and 85-100% is shown in green (good). The switchover compliance rate of SWID is 93.6% and the moving hand is at the green region of the circle, which indicates a good compliance rate.

According to one or more embodiments, the dashboard may show the plurality of assets using colors that respectively correspond to different operational statuses. The operational statuses (i.e., operational conditions) may comprise, for example, operational (e.g., running, or ready to be used), nonoperational (e.g., not ready to be used, under planned maintenance), and overdue for switchover. The dashboard may group and sort the plurality of assets based on their operational status in a table. In response to the operator labeling/marking, in the database, an asset among the plurality of assets as nonoperational for planned maintenance, the dashboard may update the asset as nonoperational for planned maintenance.

FIG. 7 shows an implementation example of S-410 to S-440. Specifically, FIG. 7 shows that the dashboard determines the operational statuses of a plurality of assets. The dashboard labels the assets, on the dashboard display, based on their operational statuses and shows them in section (702) of FIG. 7. For example, assets G101, G-7701, G-0101, G-0102, G-0301, and G-0302 are overdue assets. The overdue status may have occurred because of any reasons that made the assets noncompliant for switchover. For example, the overdue assets may have been nonoperational. The dashboard shows the overdue assets, which are not compliant, by a first color (for example red) to easily distinguish them from other assets, their overdue days, and their corresponding departments of the facility (column “unit” in the table (706)). In FIG. 7, assets G-2, G-4, G102, G103, G-9001, G-7101, G-7501, G-7301, G-7401, G-7501, G-8101, and G-8201 are running assets. The dashboard shows the running assets by a second color (for example green) and their corresponding departments of the facility. Assets G-5, G-3, G-1, G-7601, G-7801, G-7901, G-8001, G-7201, G-0701, G-0702, G-1301, G-1302, G-0501, and G-0502 are assets that are due to switchover by a specific number of days. The dashboard shows the assets that are due to switchover by a third color (for example blue), indicates their due dates, and their corresponding departments of the facility. Further, assets G-0601 and G-0602 are assets that are due for planned maintenance (DFM). The dashboard shows the assets that are due for planned maintenance by a fourth color (for example grey) and their corresponding departments of the facility.

In accordance with one or more embodiments, based on the assets conditions, the dashboard shows the switchover compliance rate of each department of the facility in section (704) of FIG. 7. For example, departments UWSP and HAWIP of the facility respectively have the switchover compliance rates of 83.3% and 88.9%. The dashboard also generates a table (706) where the dashboard can group and sort the assets based on their conditions (statuses) and provide information such as failure occurred date, switchover due date, target, remarks (comments), etc. “Target” demonstrates the time (e.g., number of days) between the time (e.g., day) the asset became nonoperational and the time (e.g., day) of a scheduled switchover.

According to one or more embodiments, the table may also comprise the following columns: Tag—represents equipment sensor in Process Book (PI) to collect needed data to calculate the switchover compliance; Last time Switched off—contains a formula or equation that counts the period of the equipment shutdown date; Status—represents whether the equipment is currently in compliance with the switchover program or not; and Switchover days limit—is the maximum period that the asset is allowed to be down before becoming incompliant.

According to one or more embodiments, in response to the nonoperational asset not being down for planned maintenance, the dashboard may determine the remaining time (e.g., number of remaining days) for switchover for the nonoperational asset. The dashboard may compare the remaining time with a first threshold and a second threshold smaller than the first threshold. In response to determining that the remaining time is equal to or less than the first threshold, the dashboard may inform an operator. The dashboard may inform the operator, for example via email, SMS, or a popup alert on a device screen, about the asset's status. Additionally, in response to determining that the remaining time (e.g., number of remaining days to the scheduled switchover) is greater than the second threshold, even if it is less than the first threshold, the dashboard may count the asset as complying with the switchover program. This is because the asset may still come back as operational by the second threshold before the switchover due date. In response to determining that the remaining time is equal to or less than the second threshold, the dashboard counts the asset as noncomplying with the switchover program.

According to one or more embodiments, in one example, the second threshold may be zero days such that if the asset is nonoperational on the due date, the dashboard counts the asset as noncomplying with the switchover program and the dashboard still counts the asset as complying on the days prior the switchover due date. Alternatively, the second threshold may be different from zero. For example, the second threshold may be 1 day before the switchover due date, by which the nonoperational asset is shown as noncompliant with the switchover program.

The dashboard may inform the operator, for example via email, SMS, or a popup alert on a device screen, about the noncomplying asset. Further, the dashboard may also count the assets that are down for planned maintenance as complying assets with the switchover program. Accordingly, the dashboard calculates a switchover compliance rate for the plurality of assets based on operational statuses of the plurality of assets.

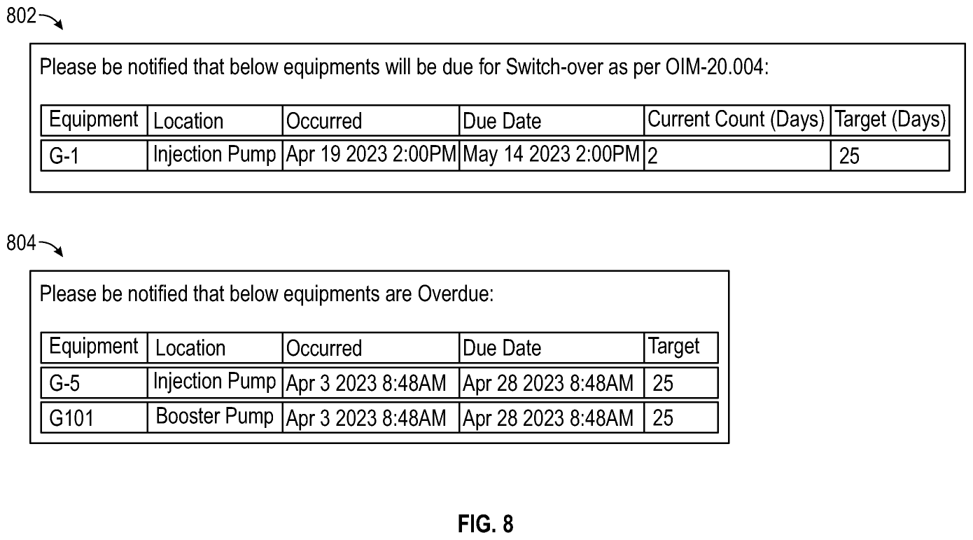

FIG. 8 shows an implementation example of generating and sending an alert to the operator, in accordance with one or more embodiments. Specifically, FIG. 8 shows that the dashboard generates alerts (802, 804) and emails them to the operator. Alert (802) informs the operator of when asset G-1 (injection pump) is due to switchover and the target days (number of days between the day the asset became nonoperational and the day of a scheduled switchover). Alert (804) informs the operator that assets G-5 (injection pump) and G101 (booster pump) are overdue for switchover, the overdue date for the switchover, and their target days.

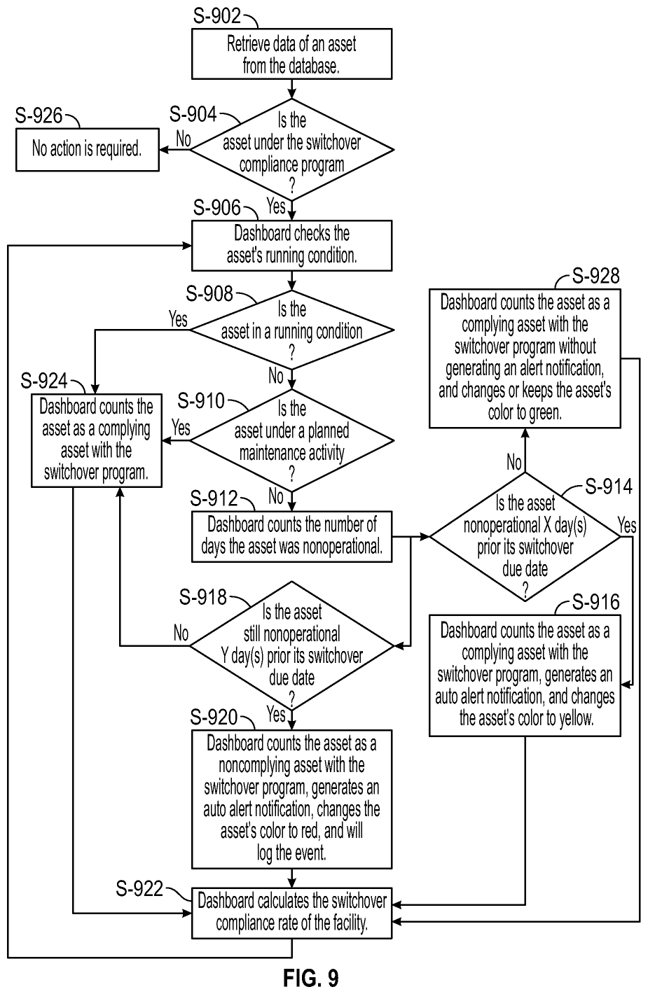

FIG. 9 shows a flowchart that illustrates an operation of the dashboard in accordance with one or more embodiments, by way of an example. In the example of FIG. 9, the first threshold is X number of day(s), as shown in S-914. And the second threshold is Y number of days, as shown in S-918. In one or more embodiments, Y may be zero, indicating that if the asset is nonoperational on the due date for switchover then the dashboard counts the asset as noncompliant with the switchover, but prior to the due date the dashboard counts the asset as compliant with the switchover program. While this flowchart is described with reference to one individual asset as an example, the dashboard can perform these operations with respect to any desired number of assets within the facility, based on the facility's specific standards.

Further, while FIG. 9, X, Y, and due date are described in terms of days, the invention is not limited by the time unit being a full day. One of ordinary skill in the art would have recognized that X or Y could be adopted into a different time unit such as a fraction of a day or that the due date may be a specific time during a specific day.

In S-902, the dashboard retrieves data of an asset from the database. In S-904, the dashboard determines whether the asset is under a switchover compliance program. If the answer to S-904 is “No,” the dashboard may take no action regarding the asset in S-926. If the answer to S-904 is “Yes,” the dashboard proceeds to S-906 where it checks the asset's running status/condition. If the asset is in a running condition (i.e., operational) in S-908, the dashboard proceeds to S-924 where it counts the asset as a complying asset with the switchover program. Otherwise (the asset not being in a running condition (nonoperational)), the dashboard proceeds to S-910 where the dashboard determines whether the asset is under planned maintenance. If yes, the dashboard proceeds to S-924 where it counts the asset as complying asset with the switchover program. Otherwise, the dashboard proceeds to S-912 where it counts the number of days the asset was nonoperational.

In S-914, the dashboard compares the number of the remaining days to the due date (i.e., number of remaining days to a scheduled switchover) of the nonoperational asset with the first threshold, X. For example, the first threshold may be 3 days, 2 days, or one day. The first threshold is determined by the switchover program. If the number of the remaining days is equal to or less than X but more than a second threshold, Y, in S-916 the dashboard automatically alerts the operator and counts the asset as complying with the switchover program. The dashboard counts the asset as complying with the switchover program in S-916 because the asset may still come back as operational by the due date of the switchover. In the alert corresponding to S-916, the dashboard may assign a specific color, such as yellow, to indicate that the type of the alert is that the asset is close to the switchover due date but is nonoperational. If the number of the remaining days is more than X, in S-928 the dashboard counts the asset as complying with the switchover program without generating the alert discussed above with reference to S-916. Further, in S-928 the dashboard indicates that the asset is operational by showing it with a specific color, for example green, on the dashboard display.

In S-918, the dashboard compares the number of the remaining days to the due date with the second threshold, Y, which is less than the first threshold X. If the number of the remaining days is equal to or less than Y, the dashboard proceeds to S-920 where it counts the asset as a noncomplying asset with the switchover program and automatically generates an alert that indicates the asset is critically close to the due date or is overdue. In the alert corresponding to S-920, the dashboard may change the color corresponding to S-916 to a different color, such as red, to indicate that the asset is overdue. Based on S-924, S-916, S-920, and S-928, the dashboard calculates the switchover compliance of the facility or a department of the facility in S-922 based on the number of compliant and noncompliant assets.

The process shown in FIG. 9 may be performed in real time as described above with reference to FIG. 5. After S-922, the dashboard goes back to S-906 to check the asset's running condition and starts from there. Thereby, the dashboard keeps the asset compliance calculations updated in real time. Further, as described above, the operator may update the records of the asset in the database. For example, the operator may update the records of the asset to indicate that the asset is under planned maintenance. Accordingly, the dashboard automatically influences any update to the asset on the dashboard's calculations and processing in real time.

The dashboard according to one or more embodiments may provide the following advantages compared to the conventional switchover compliance processes. For example, the dashboard provides access to various sections; the dashboard gives decision makers, like planning, scheduling, quality, and asset management, instant access to the status of various assets. The dashboard lowers implementation cost and time; the dashboard centralizes all organization assets' information in one place. The dashboard enables easy interaction with the user/operator; the dashboard can send notifications to operation prior the downtime of the assets and log any overdue asset for recording and investigations. The dashboard may provide meaningful insights to the user about the facility; the dashboard provides insights about strategic and operational levels to help the department plan the production and downtime of the assets. Accordingly, the dashboard can help increase productivity.

One or more embodiments disclosed herein for the operations of the dashboard, for example with reference to FIGS. 1-9, may be implemented on virtually any type of computer system, regardless of the platform being used. The computer system may have programs or algorithms to control the functions/operations of the measurement described in the above embodiments. For example, the computer system may be one or more mobile devices (e.g., laptop computer, smart phone, personal digital assistant, tablet computer, or other mobile device), desktop computers, servers, blades in a server chassis, or any other type of computer system that includes at least the minimum processing power, memory, and input and output device(s) to perform one or more embodiments of the invention.

An example of the computer system is described with reference to FIG. 10, in accordance with one or more embodiments. FIG. 10 is a block diagram of a computer system used to provide computational functionalities associated with described algorithms, methods, functions, processes, flows, and procedures as described in the instant disclosure, according to an implementation. The illustrated computer (1002) in the computer system is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1002) may include an input device, such as a keypad, keyboard, touch screen, or other device that can accept user information, and an output device that conveys information associated with the operation of the computer (1002), including digital data, visual, or audio information (or a combination of information), or a GUI.

In one or more embodiments, the dashboard described in the above embodiments may include the computer (1002), may be in the form of the computer (1002), or may be implemented on the computer (1002) such that the computer (1002) performs the processing and calculations described above with reference to FIGS. 1-9. For example, the computer (1002) on which the dashboard is implemented includes tools for fetching the assets' data from the database, processing them, and communicating with the operator or assets.

The computer (1002) can serve in a role as a client, network component, a server, a database or other persistency, or any other component (or a combination of roles) of a computer system for performing the subject matter described in the instant disclosure. The illustrated computer (1002) is communicably coupled with a network (1030). In some implementations, one or more components of the computer (1002) may be configured to operate within environments, including cloud-computing-based, local, global, or other environment (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002)) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013)). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer (1013). Software services, such as those provided by the service layer (1013), provide reusable, defined business functionalities through a defined interface. For example, the interface may be software written in JAVA, C++, Python, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004) includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure.

The computer (1002) also includes a memory (1006) that holds data for the computer (1002) or other components (or a combination of both) that can be connected to the network (1030). For example, memory (1006) can be a database storing data consistent with this disclosure. In one example, memory (1006) may store programs or algorithms for controlling operation of the dashboard that is described in the above embodiments. More specifically, in this example, the programs or algorithms may control operation of the dashboard for fetching and processing data and communicating with the assets and operators. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, the application (1007) can serve as one or more components, modules, applications, etc. In one example, the application (1007) may include programs or algorithms for controlling operation of the dashboard that is described in the above embodiments. More specifically, in this example, the programs or algorithms may control operation of the dashboard described above with reference to FIGS. 1-9. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002). In one example, the method described with reference to FIGS. 4 and 9 may be implemented by the application (1007).

There may be any number of computers (1002) associated with, or external to, a computer system containing computer (1002), each computer (1002) communicating over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers (1002). Furthermore, in one or more embodiments, the computer (1002) is a non-transitory computer readable medium (CRM).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A method of automatically managing switchover compliance performed by a switchover compliance dashboard, the method comprising:
automatically retrieving data, from a database, for each asset among a plurality of assets, wherein the data comprises information indicating whether each asset is operational or nonoperational before and on a due date for switchover,
wherein the plurality of assets comprises a pump;
determining whether each asset is operational or nonoperational based on the data before and on the due date for switchover;
in response to an asset among the plurality of assets being operational, showing the asset as operational on a dashboard display and counting the asset as complying with a switchover program;
in response to an asset among the plurality of assets being nonoperational, showing the asset as nonoperational on the dashboard display;
in response to the asset being nonoperational, determining, based on the data, whether the asset is down for planned maintenance;
in response to the nonoperational asset being down for planned maintenance, showing the asset as being down for planned maintenance on the dashboard display and counting the asset as complying with the switchover program;
in response to the nonoperational asset not being down for planned maintenance, determining whether the asset is compliant with the switchover program based on a remaining time for switchover of the asset;
based on a result of determining whether the nonoperational asset is compliant with the switchover program, showing a compliance status of the asset on the dashboard display;
calculating and showing a switchover compliance rate for the plurality of the assets based on compliance status of the plurality of assets;
in response to the nonoperational asset not being down for planned maintenance, comparing the remaining time with a first threshold and a second threshold smaller than the first threshold;
in response to determining that the remaining time is equal to or less than the first threshold, informing an operator;
in response to determining that the remaining time is greater than the second threshold, counting the asset as complying with the switchover program;
in response to determining that the remaining time is equal to or less than the second threshold, counting the asset as noncomplying with the switchover program;
grouping the plurality of assets based on their corresponding sections within a facility; and
in response to the nonoperational asset being overdue for switchover generating an alert indicating days the pump was overdue.

2. (canceled)

3. The method of claim 1, wherein the dashboard informs the operator via an email.

4. (canceled)

5. The method of claim 1, further comprising indicating a level of the switchover compliance rate via a color.

6. (canceled)

7. The method of claim 6, further comprising sending the alert to an operator.

8. The method of claim 1, wherein retrieving the data is by using Extract, Transform, and Load (ETL).

9. The method of claim 1, further comprising showing the plurality of assets on the dashboard display using different colors that respectively correspond to different operational statuses.

10. The method of claim 1, further comprising grouping and sorting the plurality of assets based on their operational statuses in a table.

11. (canceled)

12. The method of claim 1, further comprising, in response to an operator labeling an asset among the plurality of assets as nonoperational for maintenance, automatically updating the asset as nonoperational for maintenance on the dashboard display.

13. A system for automatically managing switchover compliance, the system comprising:
a plurality of assets comprising a pump; and
a server comprising a processor and a memory, the server configured to:
automatically retrieve data, from a database, for each asset among the plurality of assets, wherein the data comprises information indicating whether each asset is operational or nonoperational before and on a due date for switchover;
determine whether each asset is operational or nonoperational based on the data before and on the due date for switchover;
in response to an asset among the plurality of assets being operational, show the asset as operational on a dashboard display and count the asset as complying with a switchover program;
in response to an asset among the plurality of assets being nonoperational, show the asset as nonoperational on the dashboard display;
in response to the asset being nonoperational, determine, based on the data, whether the asset is down for planned maintenance;
in response to the nonoperational asset being down for planned maintenance, show the asset as being down for planned maintenance on the dashboard display and count the asset as complying with the switchover program;
in response to the nonoperational asset not being down for planned maintenance, determine whether the asset is compliant with the switchover program based on a remaining time for switchover of the asset;
based on a result of determining whether the nonoperational asset is compliant with the switchover program, show a compliance status of the asset on the dashboard display;
calculate and show a switchover compliance rate for the plurality of the assets based compliance status of the plurality of assets;
in response to the nonoperational asset not being down for planned maintenance, compare the remaining time with a first threshold and a second threshold smaller than the first threshold;
in response to the remaining time being equal to or less than the first threshold, inform an operator;
in response to the remaining time being greater than the second threshold, count the asset as complying with the switchover program;
in response to the remaining time being equal to or less than the second threshold, count the asset as noncomplying with the switchover program,
grouping the plurality of assets based on their corresponding sections within a facility; and
in response to the nonoperational asset being overdue for switchover generating an alert indicating days the pump was overdue.

14. (canceled)

15. (canceled)

16. The system of claim 13, wherein the server is further configured to indicate a level of switchover compliance rate via a color.

17. A non-transitory computer readable medium (CRM) storing instructions for performing an operation of automatically managing switchover compliance, the operation comprising:
automatically retrieving data, from a database, for each asset among a plurality of assets, wherein the data comprises information indicating whether each asset is operational or nonoperational before and on a due date for switchover, the plurality of assets comprise a pump;
determining whether each asset is operational or nonoperational based on the data before and on the due date for switchover;
in response to an asset among the plurality of assets being operational, showing the asset as operational on a dashboard display and counting the asset as complying with a switchover program;
in response to an asset among the plurality of assets being nonoperational, showing the asset as nonoperational on the dashboard display;
in response to the asset being nonoperational, determining, based on the data, whether the asset is down for planned maintenance;
in response to the nonoperational asset being down for planned maintenance, showing the asset as being down for planned maintenance on the dashboard display and counting the asset as complying with the switchover program;
in response to the nonoperational asset not being down for planned maintenance, determining whether the asset is compliant with the switchover program based on a remaining time for switchover of the asset;
based on a result of determining whether the nonoperational asset is compliant with the switchover program, showing a compliance status of the asset on the dashboard display;
calculating and showing a switchover compliance rate for the plurality of the assets based on compliance statuses of the plurality of assets;
in response to the nonoperational asset not being down for planned maintenance, comparing the remaining time with a first threshold and a second threshold smaller than the first threshold;
in response to determining that the remaining time is equal to or less than the first threshold, informing an operator;
in response to determining that the remaining time is greater than the second threshold, counting the asset as complying with the switchover program;
in response to determining that the remaining time is equal to or less than the second threshold, counting the asset as noncomplying with the switchover program;
grouping the plurality of assets based on their corresponding sections within a facility; and
in response to the nonoperational asset being overdue for switchover generating an alert indicating days the pump was overdue.

18. (canceled)

19. (canceled)

20. The CRM of claim 17, wherein the operation further comprises indicating a level of switchover compliance rate via a color.
